(19) United States
(12) Patent Application Publication
(10) Pub. No.: US 2016/0082538 A1
(43) Pub. Date: Mar. 24, 2016

(54) SYSTEM AND METHOD FOR DELIVERING NEGATIVE POLARITY CURRENT TO RELEASE GAS FROM A WELDING PUDDLE

(71) Applicant: LINCOLN GLOBAL, INC., City of Industry, CA (US)

(72) Inventors: STEVEN R. PETERS, HUNTSBURG, OH (US); MICHAEL S. FLAGG, AURORA, OH (US)

(21) Appl. No.: 14/491,321

(22) Filed: Sep. 19, 2014

(51) Int. Cl. B23K 9/095; B23K 9/16

(52) U.S. Cl. CPC B23K 9/0956; B23K 9/16

(57) ABSTRACT

The invention described herein generally pertains to a system and method related to reducing magnetic arc blow and steering the arc with two or more ground connections on the workpiece. The invention employs an AC switch component that is configured to activate one of the two or more ground connections to complete an electrical connection via the arc between the electrode and the workpiece. The activated ground connection can be used to counteract a buildup of magnetic field due to arc blow. Moreover, AC switch component can be configured to manipulate a direction of an arc based on activated a ground connection. In addition, AC switch component can oscillate between two or more ground connections to agitate a puddle formed by an electrode to release gas from the puddle and reduce porosity of a resulting weld.

### PRIORITY

This application relates to U.S. Non-provisional application Ser. No. 14/491,268 filed Sep. 19, 2014 and entitled “SYSTEM AND METHOD FOR GROUND SWITCHING.” The entirety of the aforementioned application is incorporated herein by reference.

### TECHNICAL FIELD

In general, the present invention relates to manipulating a direction of an arc in a welding operation by activating one of two or more ground connections on a workpiece. The present invention further relates to counteracting a buildup of magnetic field with activating one of the two or more ground connections to receive negative polarity electric current from an electric circuit that is created to form the arc. The present invention further relates to altering a shape of a puddle.

### BACKGROUND OF THE INVENTION

It is known that during welding a large current is passed from an electrode into a workpiece to be welded, and this current can generate a relatively strong magnetic field. This magnetic field has a tendency to magnetize the work piece to be welded and/or the workpiece fixtures. The magnetization of the workpiece and/or the workpiece fixture can cause the welding arc to deflect or bend from its ideal positioning which can tend to cause arc blow, or otherwise destabilize the welding arc. Furthermore, welding systems use a single ground contact to the workpiece. This creates a single current path through the workpiece during welding. However, the use of a single current path throughout a welding operation can also cause arc instability and arc blow issues as the distance and orientation between the welding operation and the ground contact point changes. Moreover, utilizing a single current path through the workpiece during welding can cause the welding arc to be biased to a single orientation during welding.

### SUMMARY OF THE INVENTION

In accordance with an embodiment of the present invention, a welder system is provided that includes a power source that creates an arc between an electrode and a workpiece, a gas that shields the arc, and a puddle that is formed by the electrode. The system can further include two or more ground connections in electric connectivity with the workpiece. The system further includes an AC switch component that is configured to select one of the two or more ground connections to complete an electrical connection via the arc between the electrode and the workpiece. The AC switch component is further configured to oscillate a ground connection between the two or more ground connections which agitates the puddle and releases gas from the puddle to reduce porosity in a weld created by the puddle.

In accordance with an embodiment of the present invention, a method is provided that includes at least the steps of: creating an arc between an electrode and a workpiece; delivering a welding wire to a puddle formed by the electrode; activating one of two or more ground connections coupled to the workpiece to complete an electrical connection between the electrode and the workpiece via the arc; and altering a shape of the puddle based on the step of activating one of the two or more ground connections.

In accordance with an embodiment of the present invention, a welder system is provided that includes at least the following: a power source that creates an arc between an electrode and a workpiece; a wire feeder that is connected to a supply of welding wire to provide a welding wire to a puddle formed by the electrode, wherein the arc is a positive polarity; the electrode and the workpiece create an electrical connection via the arc that includes a negative polarity electric current flow from the electrode, through the arc, through the workpiece, to one or more ground connections; means for detecting an amount of gas within the puddle; and means for selecting one or more ground connections to alter a shape of the puddle to release gas and reduce porosity of a weld created by the electrode.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a front view of an orbital welding system;

FIG. 2A illustrates a side view of an orbital welding system;

FIG. 2B illustrates a perspective view of an orbital welding system;

FIG. 3 is a diagram illustrating a welder system that activates one of two or more ground connections coupled to a workpiece;

FIG. 4A is a diagram illustrating a welder system that activates one of two or more ground connections coupled to a workpiece to manipulate a direction of an arc;

FIG. 4B is a top view of a welding operation that influences a direction of an arc;

FIG. 5A is a side view of a welding operation that influences a direction of an arc by utilizing two or more ground connections positioned upstream/downstream of arc;

FIG. 5B is a top view of a welding operation that influences a direction of an arc by utilizing two or more ground connections positioned upstream/downstream of arc;

FIG. 6A is a top view of a welding operation that influences a direction of an arc by utilizing two or more ground connections positioned laterally of arc;

FIG. 68 is a top view of a welding operation that influences a direction of an arc by utilizing two or more ground connections positioned laterally of arc;

FIG. 7A is a diagram illustrating a welder system that activates one of two or more ground connections coupled to a workpiece to influence a shape of a puddle;

FIG. 7B is a diagram illustrating a welder system that activates one of two or more ground connections coupled to a workpiece to influence a shape of a puddle;

FIG. 7C is a diagram illustrating a welder system that selects one of two or more ground connections coupled to a workpiece to influence a shape of a puddle;

FIG. 8 is a flow diagram of manipulating a direction of an arc by activating a ground connection to receive a negative polarity electric current from an electric circuit created by the welding operation;

FIG. 9 is a flow diagram of counteracting a buildup of magnetic fields resulting from arc blow created during a welding operation; and

FIG. 10 is a flow diagram of selecting one of two ground connections to change a shape of a puddle to release gas from the puddle and reduce porosity of a weld.

### DETAILED DESCRIPTION OF THE INVENTION

Embodiments of the invention relate to methods and systems that relate to reducing magnetic arc blow and steering the arc with a selection of two or more ground connections on the workpiece. The invention employs an AC switch component that is configured to activate one of two or more ground connections to complete an electric circuit via the arc between the electrode and the workpiece. The selection of one of the two or more ground connections can counteract a buildup of magnetic field due to arc blow. Moreover, AC switch component can be configured to activate one or more ground connections to manipulate a direction of an arc. In addition, AC switch component can oscillate activation of ground connections between the two or more ground connections in order to agitate a puddle formed by an electrode to release gas from the puddle and reduce porosity of a resulting weld.

“Welding” or “weld” as used herein including any other formatives of these words will refer to depositing of molten material through the operation of an electric arc including but not limited to submerged arc, GTAW, GMAW, MAG, MIG, TIG welding, or any electric arc used with a welding system. Moreover, the welding operation can be on a workpiece that includes a coating such as, but not limited to, a galvanized coating.

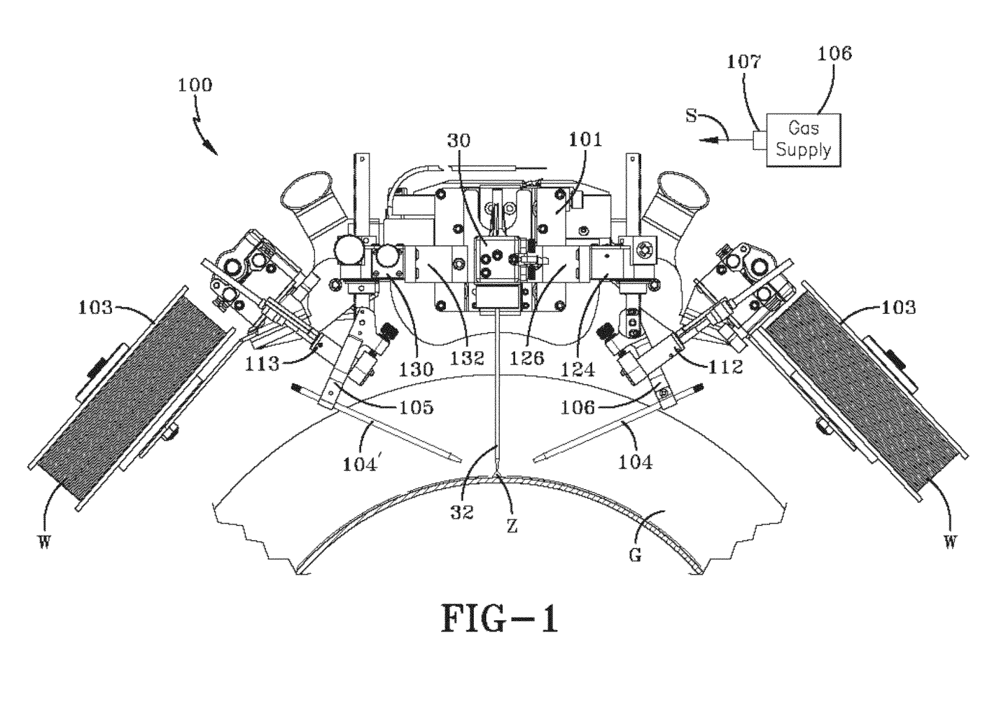

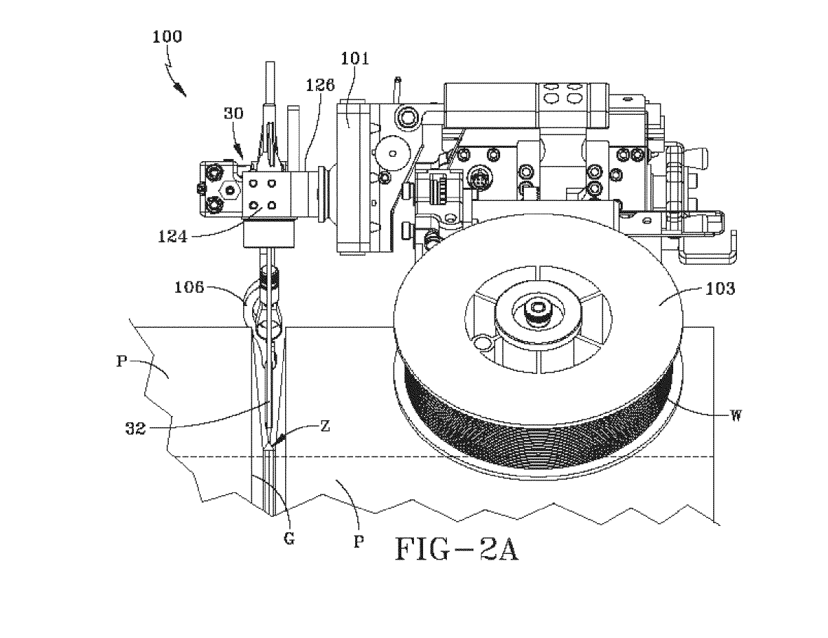

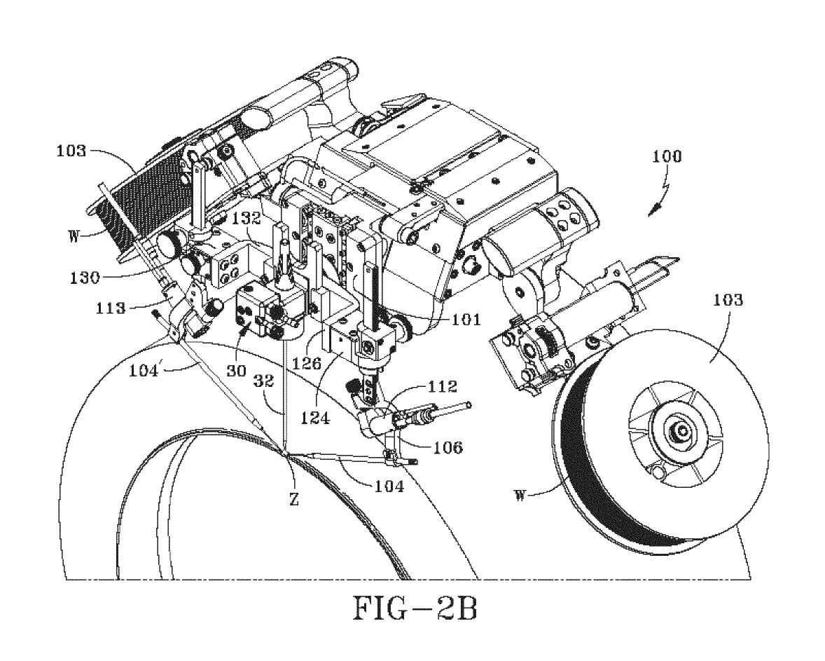

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 1-2 illustrates a welding system that is used with an automated or semi-automated welding system. One illustrative example of a welding system is orbital welding, which is often used for the joining of tubes or pipes of various types of materials. FIGS. 1-28 illustrates an example embodiment of orbital welding system 100 (also referred to as welder, system, welding system, and/or welder system) as used in an orbital welding environment. Orbital welding system 100 includes a welding tractor that travels around the pipes or tubes, a welding power source and controller, and a pendant providing operator control. It is to be appreciated that the subject innovation can be used with any orbital or non-orbital welding system. Moreover, the subject innovation can be used with any welding operation that includes an arc and a hot wire that is liquefied to deposit welding material onto a workpiece. In particular, the subject innovation can utilize two or more ground connections located on a right side and a left side of pipe P and an arc can be pulled left/right across the joint based on the activated ground connection.

System 100 (as seen in FIGS. 1-28) is generally used in deep groove welding. In the example shown, welding system 100 includes an orbital TIG welder having a welder body or chassis 101, which may be attached to the work piece or supported on a track. Welder 100 includes a welding torch, generally indicated at 30, having a welding electrode 32 for depositing weld material to form a weld joint at welding zone Z. Electrode 32 is an extended electrode having an electrode length suitable for the groove G being welded. Extended electrode 32 may have any length suitable for a given deep groove weld, including lengths greater than 10 millimeters. As depicted in the example shown, electrode length may be greater than 100 millimeters. The particular example shown has a length of about 120 millimeters. This example is not limiting as electrodes having greater or lesser lengths may be used depending on the depth of the groove G. It is to be appreciated that Gas Tungsten Arc Welding (GTAW) is an electrode negative process.

Welding torch 30 is connected to a shield gas supply 102, that provides an inert gas, such as Argon gas, to welding torch 30. Welding gas supply 102 may include a container, such as a cylinder, that stores shield gas S under pressure, and delivery of shield gas S, via appropriate tubing or other conduits, may be controlled by a regulator or other controller 107. A non-pressurized source may be used also with gas delivery provided by a pump or the like. When welding thick plates or heavy wall pipes, the weld joint design typically provides a narrow groove to permit an elongated electrode to be placed in the joint with some adjustment of the torch angle to assure a good weld created by layering a series of weld beads upon each other until the joint is filled. This process may be referred to as narrow groove welding or deep groove welding interchangeably throughout the following description. Narrow groove welding is a process where successive single bead weld layers are applied on top of one another in a narrow groove or joint. One of the considerations in the narrow groove environment is maintaining sufficient shield gas to protect the molten weld puddle from atmospheric contamination. Typically, an inert shield gas, such as Argon, is provided from outside the weld joint with a long electrode extending into the groove below the shield gas supply.

The welder may include a wire feeder connected to a supply of welding wire, such as a spool 103 that provides wire W to one or more wire guides 104′, 104. For example, wire W can be steel, stainless, nickel, among others. In the example shown, a pair of extended wire guides 104′, 104 are provided and fed by independent spools 103 located on either side of chassis 101. Wire feeder is located proximate to the wire supply (e.g., spool 103). The feeder on the right side can supply wire to the wire guide on the left. The wires can cris-cross. It is to be appreciated that one feeder can be used at a time. In an embodiment, two wire feeders can allow system 100 to go left or right without changing the system out and allowing the wire to lead tungsten electrode (32). It is to be appreciated that the support for the extended wire guides 104′, 104 can be chosen with sound engineering judgment without departing from the intended scope of coverage of the embodiments of the subject invention.

The wire guides 104′, 104 can include position device that provides automated or semi-automated motion, wherein the motion can be in any direction within a 3-dimensional environment in proximity to an arc created within welding zone Z. For instance, the wire guides 104′, 104 can extend inward and downward toward electrode 32 and welding zone Z. The example welder is supported on a track and drive by a tractor drive around pipe (also referred to as workpiece W) with wire guides 104′, 104 being located in lead and lag positions relative to welding electrode 32.

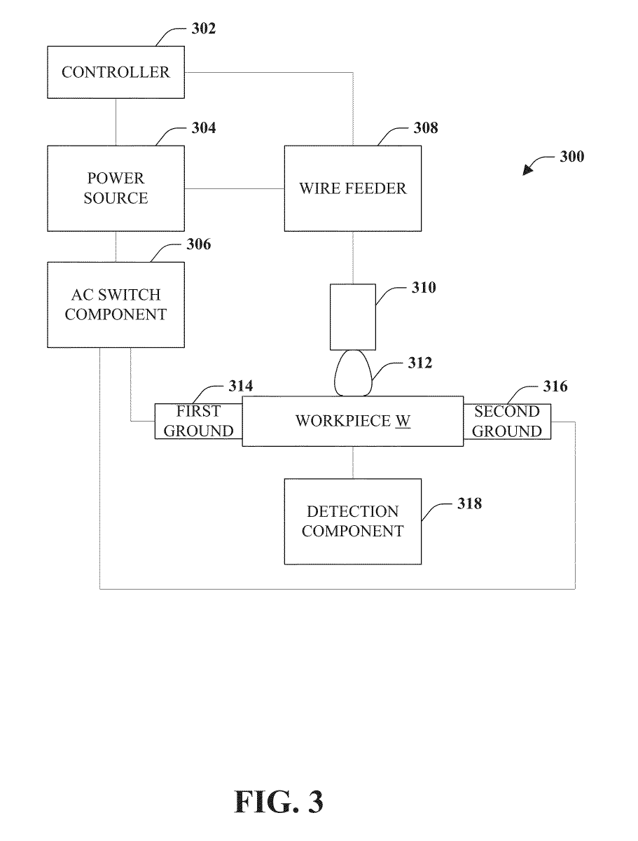

FIG. 3 illustrates welder system 300 that counteracts magnetic field buildup from arc blow by activating one of two or more ground connections such as, but not limited to first ground 314 and second ground 316 in which the activated ground connection would receive negative polarity electric current which completes an electric circuit for the welding operation. System 300 includes torch 310 having an electrode in which power source 304 creates arc 312 between electrode and workpiece W to complete an electrical circuit to perform the welding operation when a ground connection is activated by AC switch component 306. It is to be appreciated that the electrode can be a positive (+) polarity. System 300 can include power source 304 that is configured to create arc 312 between an electrode and workpiece W, wherein wire feeder 308 is configured to deliver welding wire to a puddle formed by the electrode. Controller 302 can be configured to manage wire feed speed (WFS) of wire feeder 308, power source 304 that creates arc 312, and/or AC switch component 306 to activate one or more ground connections which can receive negative polarity electric current to complete an electric circuit for the welding operation.

AC switch component 306 can be configured to activate one of a plurality of ground connections coupled to workpiece W. A negative polarity electric current would be received at the activated ground connection to complete an electric circuit used for the welding operation. In other words, the electric circuit to perform the welding operation includes an amount of negative polarity electric current that travels to a ground connection in which AC component 306 activates or selects the ground connection (first ground 314 or second ground 316 (or another ground if used)) for electron flow. AC switch component 306 can be configured to select one of two or more ground connections to counteract a magnetic field buildup from arc blow. In another embodiment, AC switch component 306 can be configured to activate one of two or more ground connections to manipulate a direction of arc 312. In still another embodiment, AC switch component 306 can be configured to select one or more ground connections to agitate a puddle formed by the electrode, wherein the agitation releases gas from the puddle to reduce porosity in the weld on workpiece W.

By way of example and not limitation, welder system 300 illustrates first ground 314 (also referred to as first ground connection) and second ground 316 (also referred to as second ground connection). However, it is to be appreciated that a number of ground connections and respective locations for ground connections can be selected with sound engineering judgment and/or by one having ordinary skill without departing from the scope of the subject innovation. For example, two or more ground connections can be positioned based upon a travel path of the welding operation (e.g., a pair of ground connections between each linear portion of the travel path, ground connections on each side of workpiece W, among others).

In an embodiment, first ground 314 can be upstream of arc 312 in comparison to a travel direction of torch 310 and second ground 316 can be downstream of arc 312 in comparison to a travel direction of torch 310. In another embodiment, first ground 314 can be lateral of arc 312 on a first side in comparison to a travel direction of torch 310 and second ground 316 can be lateral of arc 312 on a second side (opposite the first side) in comparison to a travel direction of torch 310. In another example, first ground 314 can be coupled to workpiece W at a first location and second ground 314 can be coupled to workpiece W at a second location that is opposite of the first location. In another embodiment, first ground 314 can be located on workpiece W and aligned with the material that is deposited via the welding operation and second ground 316 can be located opposite to first ground 314. In still another embodiment, first ground 314 and/or second ground 316 can be moveable during the welding operation. For example, a moveable member can be utilized with one or more ground connections to enable location change of a ground during a welding operation. Thus, a ground connection can follow torch 310 at a distance continuously through the welding operation. It is to be further appreciated that welder system 300 can include pairs of ground connections, wherein each ground connection in a pair is oppositely located to one another. The number of pairs utilized with the subject innovation can be chosen with sound engineering judgment and/or by one having ordinary skill in the art without departing from the scope of the subject innovation.

Welder system 300 can further include detection component 318 that is configured to measure a magnetic field buildup due to arc blow. Based on the magnetic field buildup measured by detection component 318, AC switch component 306 can be configured to select a ground connection to receive negative polarity current to complete an electric current for the welding operation. In an embodiment, the selected ground connection can be a ground connection that is closest to where the magnetic field buildup is on workpiece W. Thus, activating a ground connection closest to the magnetic field buildup on workpiece W counteracts arc blow.

It is to be appreciated that detection component 318 can be configured to approximate an amount of magnetic field buildup rather than specifically detect an amount of magnetic field buildup for the welding operation based on one or more welding parameters. For instance, based on an approximation of magnetic field buildup in workpiece W, AC switch component 306 can activate one or more ground connections to counteract the magnetic field buildup. The approximation of an amount of magnetic field buildup can be performed by a technique selected by sound engineering judgment or by one having ordinary skill without departing from the subject innovation. By way of example and not limitation, the approximation of magnetic field buildup by detection component 318 can be based on a duration of time welding, a type of welding operation, a location of the welding operation is performed on the workpiece, a type of material of workpiece W, a wire feed speed, a type of welding wire, a waveform used to create an arc, among others.

In another embodiment, detection component 318 can be configured to ascertain a location on workpiece W that is indicative of having a buildup of magnetic field due to arc blow, wherein AC switch component 306 can be configured to select a ground connection based on the location on workpiece W. For example, detection component 318 can detect one or more edges of workpiece W in comparison to a travel path of the welding operation and AC switch component 306 can select a ground connection at one or more edges to counteract magnetic field buildup. In another embodiment, detection component 318 can be configured to detect an edge in a “V” grove that is to be filled by the welding operation, wherein the welding operation uses a weave pattern. In a non-limiting example, detection component 318 can detect an edge at a start or end of a welding operation and AC switch component 306 can be configured to select a ground connection located proximate to the edge to counteract a buildup of magnetic field due to arc blow.

In still another embodiment, detection component 318 can be configured to detect an amount of gas in the puddle formed by the electrode. Based on the gas detected by detection component 318, AC switch component 306 can be configured to select a ground connection or select ground connections. For instance, AC switch component 306 can be configured to activate one or more ground connections to alter a shape of the puddle, wherein the altering of the shape of the puddle releases gas and reduces porosity. By way of example and not limitation, AC switch component 306 can oscillate between a first ground connection and a second ground connection (or multiple pairs of ground connections), wherein the first ground connection is located opposite of the first ground connection. The oscillation between two ground connections opposite one another creates a magnetic force that agitates the puddle such that the puddle is elongated toward the ground connection that completes the electric circuit for the welding operation.

It is to be appreciated that detection component 318 can be configured to approximate an amount of gas rather than specifically detect an amount of gas for the welding operation based on one or more welding parameters. For instance, based on an approximation of gas in a puddle, AC switch component 306 can select between one or more ground connections to agitate the puddle and release gas. The approximation of an amount of gas can be selected by sound engineering judgment or by one having ordinary skill without departing from the subject innovation. By way of example and not limitation, the approximation of gas by detection component 318 can be based on a duration of time welding for a type of welding operation and/or a type of material of workpiece W.

In an embodiment, AC switch component 306 can select ground connections in an oscillating pattern to elongate and/or squeeze (e.g., constrict, contract, shorten, etc.) a puddle formed by the electrode. For example, a plurality of ground connections can be places on a perimeter of workpiece W and each ground connection (e.g., one at-a-time) can be activated in a rotating pattern (e.g., clockwise, counterclockwise, etc.). However, it is to be appreciated that various locations for ground connections can be used when coupling to workpiece W and various patterns for the active ground can be used when agitating and/or moving a puddle formed by the electrode. Thus, one of sound engineering judgment and/or one having ordinary skill can select an amount of ground connections, a location for the amount of ground connections, and/or a pattern to activate the ground connections without departing from the scope of the subject innovation.

It is to be appreciated and understood that system 300 can include various configurations and embodiments and the configuration in system 300 is not to be limiting on the subject innovation. Wire feeder 308 can be a stand-alone component (as depicted), incorporated into AC switch component 306, incorporated into power source 304, incorporated into controller 302, incorporated into torch 310, or any suitable combination thereof. Power source 304 can be a stand-alone component (as depicted), incorporated into AC switch component 306, incorporated into controller 302, incorporated into wire feeder 308, incorporated into torch 310, or any suitable combination thereof. AC switch component 306 can be a stand-alone component (as depicted), incorporated into controller 302, incorporated into power source 304, incorporated into wire feeder 308, incorporated into torch 310, or any suitable combination thereof. Moreover, it is to be appreciated that system 300 can include one or more power sources 304 and the system 300 can be adapted to utilize multiple power sources, a single power source (as depicted), shared power sources, or a combination thereof. For example, a power source can be included for energizing welding wire or an additional electrode in a multiple electrode welder system. Controller 302 can be a stand-alone component (as depicted), incorporated into AC switch component 306, incorporated into power source 304, incorporated into wire feeder 308, incorporated into torch 310, or any suitable combination thereof.

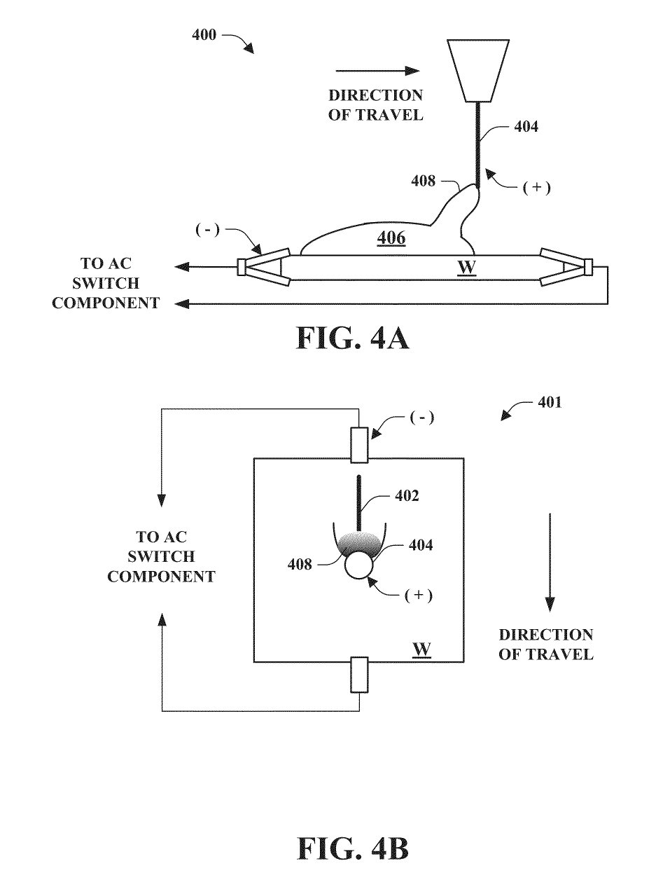

FIG. 4A illustrates side view 400 of a welding operation that influences a direction of arc 408. Side view 400 includes electrode 404 that has a positive (+) polarity, wherein arc 408 is created between workpiece W and electrode 404. Upon delivery of welding wire into puddle 406 formed by electrode 404, welding wire is liquefied and becomes deposited welding material into puddle 406 on workpiece W. Since AC switch component 306 is configured to activate one of two or more ground connections, arc 408 direction is manipulated to attract toward the ground connection that is activated. It is to be appreciated that direction of arc 408 can further be manipulated by AC switch component 306 discussed above (e.g., location/movement of ground connections in relation to arc 408, activation/de-activation of ground connections, and the like).

FIG. 4B illustrates top view 401 of a welding operation that influences a direction of arc 408. Top view 401 includes arc 408 that has a positive (+) polarity, wherein arc 408 is created between workpiece W and electrode 404. Upon delivery of welding wire into puddle formed by electrode 404, welding wire is liquefied and becomes deposited welding material into puddle on workpiece W and fill joint 402. Since AC switch component 306 is configured to select one of two or more ground connections, arc 408 direction is manipulated to attract toward the selected ground connection. In the example illustrated in FIG. 4B, a first ground connection, opposite a second ground connection, is activated wherein the first ground connection is upstream from the arc in comparison to the direction of travel and the second ground connection is downstream from the arc in comparison to the direction of travel. It is to be appreciated that direction of arc 408 can further be manipulated by AC switch component 306 discussed above (e.g., location/movement of ground connections in relation to arc 408, activation/de-activation of ground connections, and the like).

For instance, the two or more ground connections can be positioned on the workpiece W based on a path for the welding operation such that each pair of ground connections can correspond to a linear path of travel for the welding operation. In another example, two or more ground connections can be utilized in various locations/positions to manipulate the direction of arc 408. It is to be appreciated that a location of where the two or more ground connections is placed in relation to electrode 404 can be any suitable location on workpiece W (e.g., upstream, downstream, lateral, on top of workpiece, below workpiece, left, right, side, etc., any combination thereof).

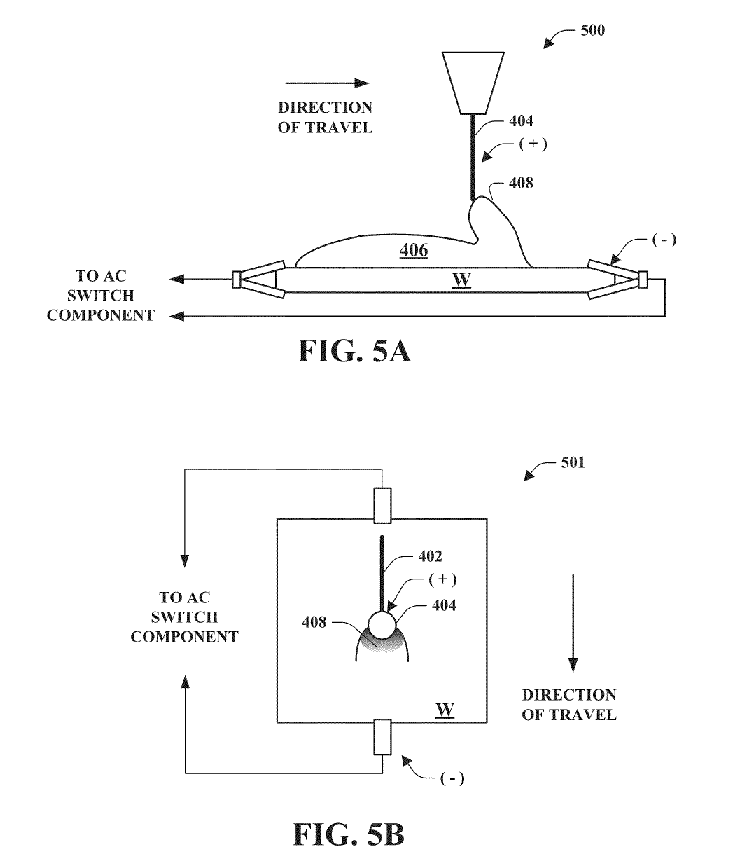

FIG. 5A illustrates side view 500 of a welding operation that influences a direction of arc 408 by utilizing two or more ground connections positioned upstream/downstream of arc 408 in comparison to a direction of travel of the welding operation. Side view 500 includes electrode 404 that has a positive (+) polarity, wherein arc 408 is created between workpiece W and electrode 404. Upon delivery of welding wire into puddle 406 formed by electrode 404, welding wire is liquefied and becomes deposited welding material into puddle 406 on workpiece W. Since AC switch component 306 is configured to activate one of two or more ground connections, arc 408 direction is manipulated to attract toward the activated ground connection which received negative polarity electric current. It is to be appreciated that direction of arc 408 can further be manipulated by AC switch component 306 discussed above (e.g., location/movement of ground connections in relation to arc 408, activation/de-activation of ground connections, and the like).

FIG. 5B illustrates top view 501 of a welding operation that influences a direction of arc 508 by utilizing two or more ground connections positioned upstream/downstream of arc 408 in comparison to a direction of travel of the welding operation. Top view 501 includes arc 408 that has a positive (+) polarity, wherein arc 408 is created between workpiece W and electrode 404. Upon delivery of welding wire into puddle formed by electrode 404, welding wire is liquefied and becomes deposited welding material into puddle on workpiece W and fill joint 402. Since AC switch component 306 is configured to select one of two or more ground connections, arc 408 direction is manipulated to attract toward the selected ground connection which received negative polarity electric current to complete an electric circuit used for the welding operation. In the example illustrated in FIG. 5B, a first ground connection, opposite a second ground connection, is activated wherein the first ground connection is downstream from the arc in comparison to the direction of travel and the second ground connection is upstream from the arc in comparison to the direction of travel. It is to be appreciated that direction of arc 408 can further be manipulated by AC switch component 306 discussed above (e.g., location/movement of ground connections in relation to arc 408, activation/de-activation of ground connections, and the like).

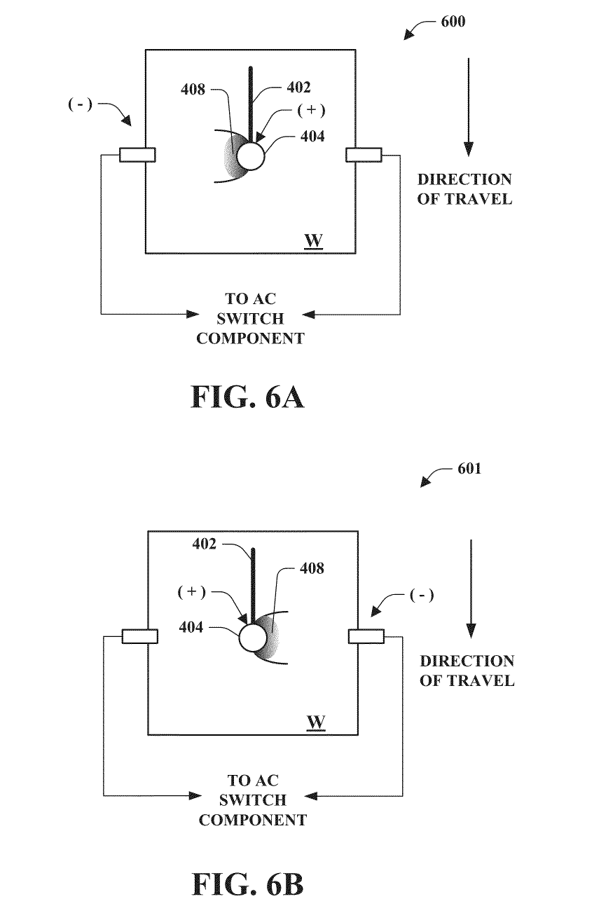

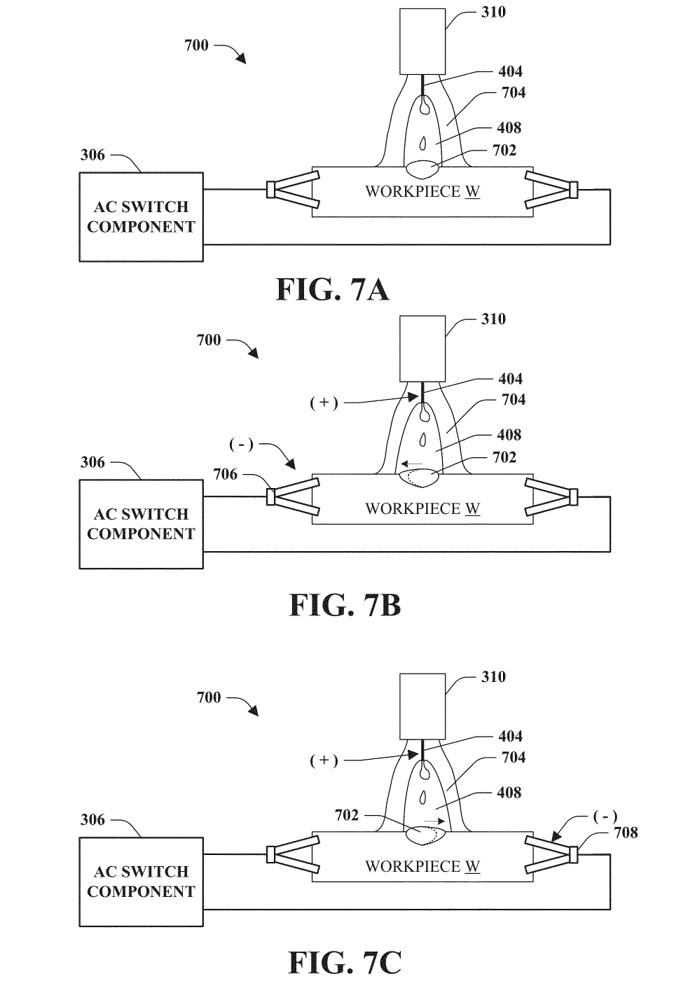

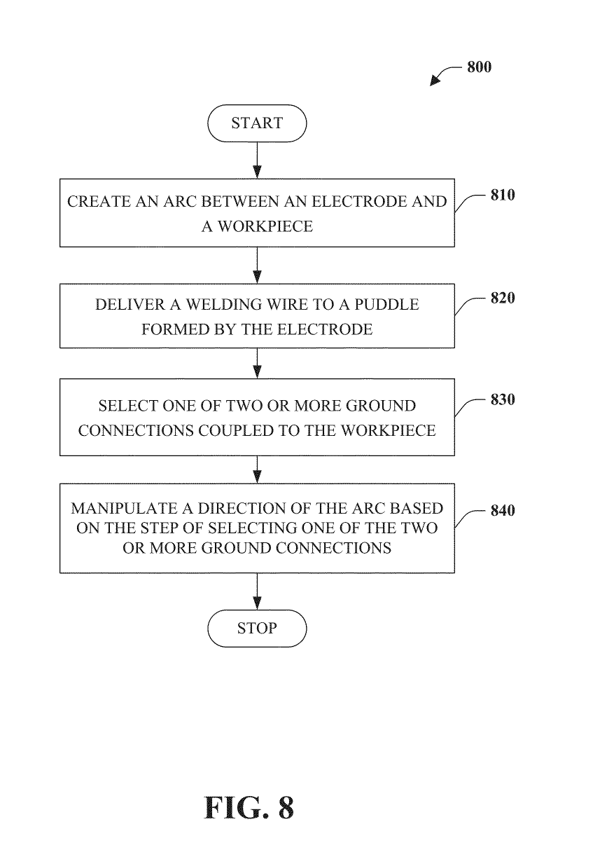

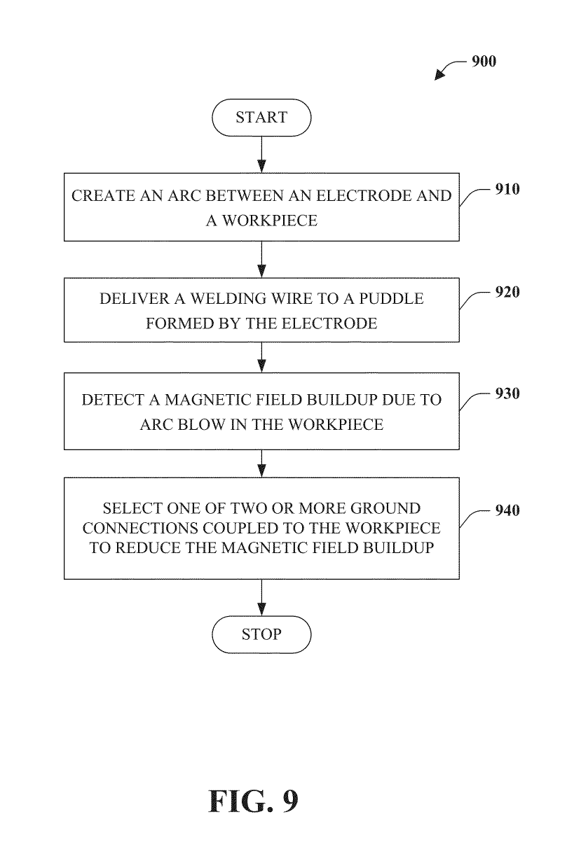

FIG. 6A illustrates top view 600 of a welding operation that influences a direction of arc 408 by utilizing two or more ground connections positioned laterally of arc 408 in comparison to a direction of travel of the welding operation. Top view 600 includes arc 408 that has a positive (+) polarity, wherein arc 408 is created between workpiece W and electrode 404. Upon delivery of welding wire into puddle formed by electrode 404, welding wire is liquefied and becomes deposited welding material into puddle on workpiece W and fill joint 402. Since AC switch component 306 is configured to activate one of two or more ground connections, arc 408 direction is manipulated to attract toward the activated ground connection to complete the electric circuit for the welding operation and be the active ground. In the example illustrated in FIG. 6A, a first ground connection, opposite a second ground connection, is activated wherein the first ground connection is on a first side lateral from the arc and the second ground connection is on a second side lateral from the arc. It is to be appreciated that direction of arc 408 can further be manipulated by AC switch component 306 discussed above (e.g., location/movement of ground connections in relation to arc 408, activation/de-activation of ground connections, and the like).

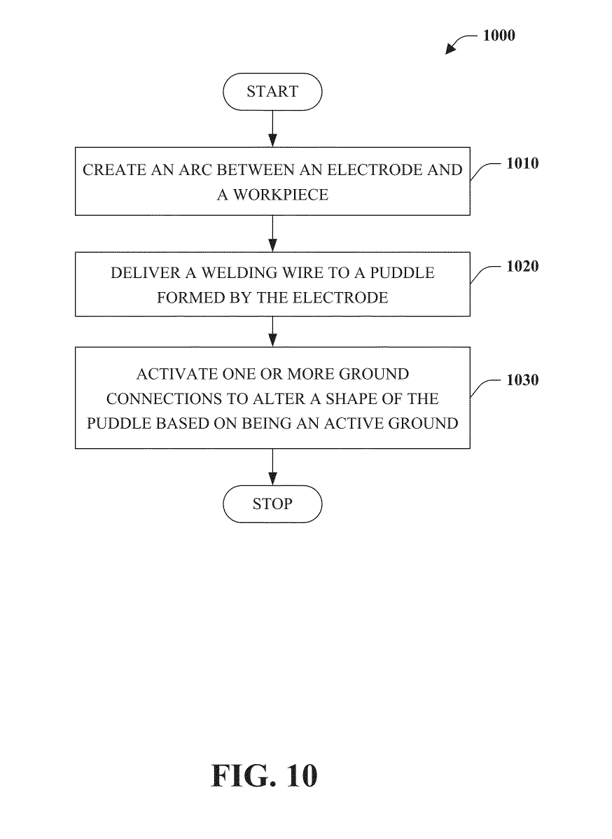

FIG. 68 illustrates top view 601 of a welding operation that influences a direction of arc 508 by utilizing two or more ground connections positioned laterally of arc 408 in comparison to a direction of travel of the welding operation. Top view 601 includes arc 408 that has a positive (+) polarity, wherein arc 408 is created between workpiece W and electrode 404. Upon delivery of welding wire into puddle formed by electrode 404, welding wire is liquefied and becomes deposited welding material into puddle on workpiece W and fill joint 402. Since AC switch component 306 is configured to select one of two or more ground connections, arc 408 direction is manipulated to attract toward the selected ground connection. In the example illustrated in FIG. 68, a first ground connection, opposite a second ground connection, is selected wherein the first ground connection is on a first side lateral from the arc and the second ground connection is on a second side lateral from the arc. It is to be appreciated that direction of arc 408 can further be manipulated by AC switch component 406 discussed above (e.g., location/movement of ground connections in relation to arc 408, activation/de-activation of ground connections, and the like).

FIG. 7A illustrates welder system 700 that includes AC switch component 306 that is configured to activate a ground connection to receive negative polarity electric current (e.g., a ground current) from workpiece W (and in particular to one of the two or more ground connections), wherein the activated ground connection completes an electrical connection between electrode 404. Welder system 700 can include torch 310 having electrode 404. A power source can be configured to create arc 408 between electrode 404 and workpiece W. Puddle 702 can be formed by delivering welding wire to arc 408 to deposit material onto workpiece W. In particular, shielding gas 704 can be utilized with the welding operation performed by welder system 700. For example, workpiece W can be a material that is a galvanized coated plate. FIG. 7A illustrates welder system 700 in which AC switch component 306 is not activating one or more ground connections and the welding operation is shown still for illustrative purposes. AC switch component 306 can be configured to activate one or more ground connections, wherein the activated ground connection generates a negative polarity electric current (e.g., completing a ground connection for the welding operation electric circuit) alters a shape of puddle 702. Based on the location of the ground connection that is activated, arc 408 and puddle 702 will be attracted thereto based on opposite polarities attracting one another.

Turning to FIGS. 7B and 7C, welder system 700 is illustrated in which one of two or more ground connections is activated to receive negative polarity electric current to complete a circuit to perform the welding operation to workpiece W via AC switch component 306. Puddle 702 can be altered in shape by activating ground connection 706 or ground connection 708, wherein the activation of the activated ground connection creates a ground connection for an electrical circuit for the welding operation (e.g., from electrode 404, through arc 408, through puddle 702, through workpiece W, to an activated ground connection). As illustrated in FIG. 7B, ground connection 706 can be activated which attracts arc 408 and puddle 702. As illustrated in FIG. 7C, ground connection 708 can be activated which attracts arc 408 and puddle 702. For instance, the ground connection can be selected and utilized to receive negative polarity electric current to manipulate a shape of puddle 702. By way of example and not limitation, the shape of puddle 702 can be altered (e.g., pushed, pulled, stretched, squeezed, constricted, contracted, shortened, among others) based on a location of a ground connection on the workpiece W (e.g., upstream, downstream, lateral, among others) and/or which ground connection is activated.

Further, selecting two or more ground connections alters a shape of puddle 702 which releases gas from puddle 702. By releasing gas from puddle 702 during the welding operation with AC switch component 306, porosity of the weld on workpiece W is reduced. For instance, with a first ground connection upstream (aligned with a travel direction of the welding operation) and a second ground connection downstream (opposite the first ground connection and aligned with the travel direction), AC switch component 306 can be configured to oscillate an active ground between the first ground connection and the second ground connection. Moreover, the frequency of oscillation of an active ground between the two or more ground connections can be chosen by sound engineering judgment and/or one having ordinary skill without departing from the subject innovation. For instance, a detection component can be utilized to detect an amount of gas in puddle 702 in which AC switch component 306 selects one or more ground connections. For example, an amount of gas detected can correspond to a pattern (e.g., oscillating, constant, varying, alternating, etc.) of activation for one or more ground connections. In an embodiment, the pattern can be alternating between the two or more ground connections, a predefined pattern, a pattern based on a detection of gas that needs to be released, a pattern based on a detection of where gas buildup is in puddle 802, among others.

AC switch component 306 can be configured to agitate puddle 702 with selecting two or more ground connections. It is to be appreciated that the activation of ground connections by AC switch component 306 and selection of locations for ground connections can be based on a welding parameter. By way of example and not limitation, the welding parameter can be, but is not limited to, a type of welding operation, a type of shielding gas, a material composition of workpiece W, a welding pattern, a type of electrode, a composition of electrode, a wire feed speed, a waveform used for the welding operation, a polarity of a welding wire, a type of flux, a number of electrodes used in the welding operation, an arc voltage, a travel speed of a tractor welder that performs the welding operation, an arc current level, a height of torch, a distance between workpiece W and torch, an oscillation width of electrode, a temperature of welding wire, a temperature of electrode, a type of material of workpiece W, a frequency of oscillation of electrode, a polarity of the arc current, a polarity of the current for welding wire, a parameter that affects an arc current of the welding operation, a gauge of wire, a material of wire, oscillation dwell, left oscillation dwell, right oscillation dwell, any and all variation of advanced process controls (e.g., move controls, pulse-frequency, ramp rates, background level ratios, etc.), and the like.

In an embodiment, the arc is created from at least one of a gas metal arc welding (GMAW) in which the electrode is a positive polarity. In an embodiment, the system can include a detection component that is configured to measure a magnetic field buildup due to arc blow in the workpiece. In the embodiment, the AC switch component selects one of the two or more ground connections to counteract the magnetic field buildup due to arc blow in the workpiece. In the embodiment, the AC switch component selects one of the two or more ground connections that is a shortest distance to a location on the workpiece that the magnetic field buildup is detected on the workpiece (e.g., the electrical current will take the path of least resistance and thus to the ground that is closest to the arc). In another embodiment, a GTAW welding operation can include an electrode that has a negative polarity in which the attraction and/or repel forces would interact with the ground connection accordingly (e.g., positive polarity attracts to negative polarity, negative polarity repels from negative polarity, etc.).

In an embodiment, the two or more ground connections include a first ground connection located on the workpiece behind the arc approximately aligned with a travel direction of the welding operation and a second ground connection located on the workpiece ahead the arc approximately aligned with the travel direction of the welding operation.

In an embodiment, the two or more ground connections include a first ground connection located on the workpiece downstream of the arc compared to a travel direction of the welding operation and a second ground connection located on the workpiece upstream of the arc compared to the travel direction of the welding operation. In the embodiment, the AC switch component is further configured to select the first ground connection to influence the direction of the arc downstream compared to the travel direction of the welding operation. In the embodiment, the AC switch component is further configured to select the second ground connection to influence the direction of the arc upstream compared to the travel direction of the welding operation.

In an embodiment, the two or more ground connections include a first ground connection opposite a second ground connection, the first ground connection and the second ground connection are coupled to the workpiece. In an embodiment, the two or more ground connections include a first ground connection located on the workpiece lateral of the arc compared to a travel direction of the welding operation and a second ground connection located on the workpiece lateral of the arc, opposite and remote the first ground connection, compared to the travel direction of the welding operation. In an embodiment, at least one of the two or more ground connections are located on an exterior edge of the workpiece.

In an embodiment, at least one of the two or more ground connections are located on an interior surface of the workpiece. In an embodiment, the AC switch component is further configured to switch between the two or more ground connections. In an embodiment, the AC switch component is further configured to oscillate a ground connection between two of the two or more ground connections.

In an embodiment, the workpiece is galvanized coated. In an embodiment, the system can include a detection component that is configured to measure an amount of gas in the puddle. In the embodiment, the AC switch component selects one of the two or more ground connections to alter a shape of the puddle to release the amount of gas in the puddle. In the embodiment, detection component is further configured to detect a location of an amount of gas in the puddle. In the embodiment, the AC switch component selects two or more ground connections to agitate the location of the amount of gas in the puddle.

In an embodiment, AC switch component activates the first ground connection for a first period of time and then activates the second ground connection for a second period of time. In an embodiment, the first period of time is equal to the second period of time.

In an embodiment, the system can further include the two or more ground connections are coupled to the workpiece around a perimeter of the workpiece and the AC switch component is further configured to activate two or more ground connections in a pattern coupled to the workpiece around the perimeter. In the embodiment, the pattern is a clockwise pattern or a counterclockwise pattern around the perimeter.

In view of the exemplary devices and elements described supra, methodologies that may be implemented in accordance with the disclosed subject matter will be better appreciated with reference to the flow charts and/or methodology of FIGS. 8-10. The methodologies and/or flow diagrams are shown and described as a series of blocks, the claimed subject matter is not limited by the order of the blocks, as some blocks may occur in different orders and/or concurrently with other blocks from what is depicted and described herein. Moreover, not all illustrated blocks may be required to implement the methods and/or flow diagrams described hereinafter.

Sequentially, the following occurs as illustrated in the decision tree flow diagram 800 of FIG. 9 which is a flow diagram 800 that provides counteracting a buildup of magnetic fields resulting from arc blow created during a welding operation. At reference block 810, an arc between an electrode and a workpiece can be created. At reference block 820, a welding wire can be delivered to the arc. At reference block 830, one of two or more ground connections coupled to the workpiece can be selected. The selection can allow negative polarity electric current to travel from the electrode, through the arc, through the workpiece, to the selected ground connection. At reference block 840, a direction of the arc can be manipulated based on the step of selecting one of the two or more ground connections.

It is to be appreciated that the subject innovation can activate more than one ground connection at a time. In a particular embodiment, the negative polarity electric current (which completes the electric circuit for the welding operation) can be received by more than one ground connection at a time. In another embodiment, the subject innovation can activate each ground connection for a respective duration of time. For instance, a first ground connection can be activated for a first period of time and a second ground connection can be activated for a second period of time, where the first period of time is not equal to the second period of time.

FIG. 9 illustrates a flow diagram 900 that provides manipulating a direction of an arc. At reference block 910, an arc between an electrode and a workpiece can be created. At reference block 920, a welding wire can be delivered to the arc. At reference block 930, a magnetic field buildup due to arc blow can be detected in the workpiece. At reference block 940, one of two or more ground connections coupled to the workpiece can be selected to reduce the magnetic field buildup. The selection can allow negative polarity electric current to travel from the electrode, through the arc, through the workpiece, to the selected ground connection.

FIG. 10 illustrates a flow diagram 1000 that provides changing a shape of a puddle to release gas from the puddle and reduce porosity of a weld. At reference block 1010, an arc between an electrode and a workpiece can be created. At reference block 1020, a welding wire can be delivered to a puddle formed by the electrode. At reference block 1030, one or more ground connections can be activated to alter a shape of the puddle based on being an active ground. In particular, the shape of the puddle can be altered to release gas from the puddle to reduce porosity of the weld created.

In an embodiment, the method can further include detecting the magnetic arc blow at a location that is upstream of the arc in comparison to a travel direction and activating one of the two or more ground connections that is at a location that is upstream of the arc.

In an embodiment, the method can further include detecting the magnetic arc blow at a location that is downstream of the arc in comparison to a travel direction and activating the negative polarity electric current to one of the two or more ground connections that is at a location that is downstream of the arc.

In an embodiment, the two or more ground connections include a first ground connection is at a location opposite a second ground connection.

In an embodiment, the method can include the step of altering the shape of the puddle further comprises elongating the puddle and constricting the puddle to release gas from the puddle and reduce porosity. In an embodiment, the method can include selecting one of the two or more ground connections based on lapse of an amount of time from when the arc is created. In an embodiment, the method can include the two or more ground connections include a first ground connection is at a location opposite a second ground connection.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welder system, comprising:
a power source that creates an arc between an electrode and a workpiece;
a gas that shields the arc;
a puddle that is formed by the electrode;
two or more ground connections in electric connectivity with the workpiece;
an AC switch component that is configured to activate one of the two or more ground connections to complete an electrical connection via the arc between the electrode and the workpiece; and
the AC switch component is further configured to oscillate a ground connection to complete the electrical connection between the two or more ground connections which agitates the puddle and releases gas from the puddle to reduce porosity in a weld created by the puddle.

2. The welder system of claim 1, wherein the workpiece is galvanized coated.

3. The welder system of claim 1, further comprising a detection component that is configured to measure an amount of gas in the puddle.

4. The welder system of claim 3, the AC switch component activates one of the two or more ground connections to alter a shape of the puddle to release the amount of gas in the puddle.

5. The welder system of claim 3, the detection component is further configured to detect a location of an amount of gas in the puddle.

6. The welder system of claim 5, the AC switch component activates two or more ground connections to agitate the location of the amount of gas in the puddle.

7. The welder system of claim 1, wherein the two or more ground connections include a first ground connection located on the workpiece behind the arc approximately aligned with a travel direction of the welding operation and a second ground connection located on the workpiece ahead the arc approximately aligned with the travel direction of the welding operation.

8. The welder system of claim 1, wherein the two or more ground connections include a first ground connection located on the workpiece downstream of the arc compared to a travel direction of the welding operation and a second ground connection located on the workpiece upstream of the arc compared to the travel direction of the welding operation.

9. The welder system of claim 1, wherein the two or more ground connections include a first ground connection located on the workpiece lateral of the arc compared to a travel direction of the welding operation and a second ground connection located on the workpiece lateral of the arc, opposite and remote the first ground connection, compared to the travel direction of the welding operation.

10. The welder system of claim 1, wherein the two or more ground connections include a first ground connection opposite a second ground connection, the first ground connection and the second ground connection are coupled to the workpiece.

11. The welder system of claim 10, the AC switch component oscillates the ground connection between the first ground connection and the second ground connection.

12. The welder system of claim 1, the AC switch component activates the first ground connection for a first period of time and then activates the second ground connection for a second period of time.

13. The welder system of claim 1, wherein the first period of time is equal to the second period of time.

14. The welder system of claim 1, further comprising:
the two or more ground connections are coupled to the workpiece around a perimeter of the workpiece; and
the AC switch component is further configured to activate two or more ground connections coupled to the workpiece around the perimeter.

15. The welder system of claim 14, wherein the pattern is a clockwise pattern or a counterclockwise pattern around the perimeter.

16. A method of welding, comprising:
creating an arc between an electrode and a workpiece;
delivering a welding wire to a puddle formed by the electrode;
selecting one of two or more ground connections coupled to the workpiece to complete an electrical connection between the electrode and the workpiece via the arc; and
altering a shape of the puddle based on the step of selecting one of the two or more ground connections.

17. The method of claim 16, wherein the step of altering the shape of the puddle further comprises elongating the puddle and constricting the puddle to release gas from the puddle and reduce porosity.

18. The method of claim 16, further comprising activating one of the two or more ground connections based on lapse of an amount of time from when the arc is created.

19. The method of claim 16, wherein the two or more ground connections include a first ground connection is at a location opposite a second ground connection.

20. A welder system, comprising:
a power source that creates an arc between an electrode and a workpiece;
a wire feeder that is connected to a supply of welding wire to provide a welding wire to a puddle formed by the electrode, wherein the arc is a positive polarity;
the electrode and the workpiece create an electrical connection via the arc that includes a negative polarity electric current flow from the electrode, through the arc, through the workpiece, to one or more ground connections;
means for detecting an amount of gas within the puddle; and
means for selecting one or more ground connections to alter a shape of the puddle to release gas and reduce porosity of a weld created by the electrode.
